(19) United States
(12) Patent Application Publication
(10) Pub. No.: US 2006/0184938 A1
(43) Pub. Date: Aug. 17, 2006

(54) Method, apparatus and system for dynamically reassigning memory from one virtual machine to another

(75) Inventor: Richard P. Mangold, Forest Grove, OR (US)

Correspondence Address: INTEL CORPORATION, P.O. BOX 5326, SANTA CLARA, CA, 95056-5326, US

(73) Assignee: INTEL CORPORATION

(21) Appl. No.: 11/062,202

(22) Filed: Feb. 17, 2005

(51) Int. Cl. G06F 9/455

(52) U.S. Cl. 718/1

(57) ABSTRACT

A method, apparatus and system enable a virtual machine manager (“VMM”) to dynamically reassign memory from one virtual machine (“VM”) to another. The VMM may generate a message to the VM to which the memory is currently assigned and inform the device that the memory is shutting down. The current VM may thereafter copy the contents of the memory to the host hard disk and eject the memory. The VMM may then inform another VM that the memory is available, and the second VM may then add the memory to its available memory resources.

### BACKGROUND

Interest in virtualization technology is growing steadily as processor technology advances. One aspect of virtualization technology enables a single host computer running a virtual machine monitor (“VMM”) to present multiple abstractions and/or views of the host, such that the underlying hardware of the host appears as one or more independently operating virtual machines (“VMs”). Each VM may function as a self-contained platform, running its own operating system (“OS”) and/or a software application(s). The VMM manages allocation of resources on the host and performs context switching as necessary to cycle between various virtual machines according to a round-robin or other predetermined scheme.

### BRIEF DESCRIPTION OF THE DRAWINGS

The present invention is illustrated by way of example and not limitation in the figures of the accompanying drawings in which like references indicate similar elements, and in which:

FIG. 1 illustrates an example of a typical virtual machine host;

FIG. 2 illustrates an overview of an embodiment of the present invention;

FIG. 3 illustrates an overview of assigning the “ejected” memory in FIG. 2 to a new VM according to one embodiment of the present invention; and

FIG. 4 is a flowchart illustrating an embodiment of the present invention.

### DETAILED DESCRIPTION

Embodiments of the present invention provide a method, apparatus and system for dynamically reassigning resources from one virtual machine to another without having to reboot the operating systems on the virtual machine(s). Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

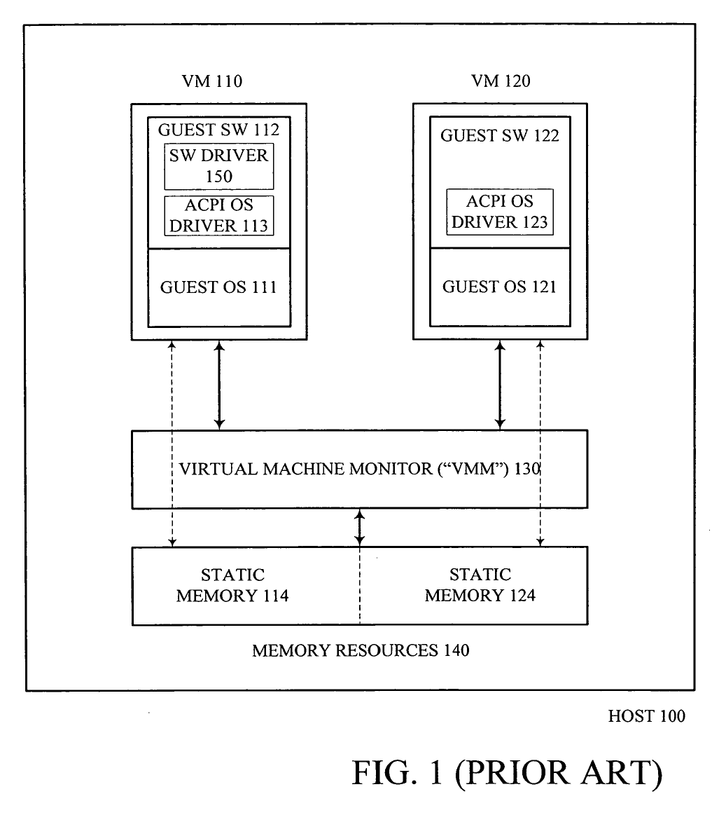

FIG. 1 illustrates an example of a typical virtual machine host platform (“Host 100”). As previously described, a virtual-machine monitor (“VMM 130”) typically runs on the host platform and presents an abstraction(s) and/or view(s) of the platform (also referred to as “virtual machines” or “VMs”) to other software. Although only two VM partitions are illustrated (“VM 110” and “VM 120”, hereafter referred to collectively as “VMs”), these VMs are merely illustrative and additional virtual machines may be added to the host. VMM 130 may be implemented in software (e.g., as a standalone program and/or a component of a host operating system), hardware, firmware and/or any combination thereof.

VM 110 and VM 120 may function as self-contained platforms respectively, running their own “guest operating systems” (i.e., operating systems hosted by VMM 130, illustrated as “Guest OS 111” and “Guest OS 121” and hereafter referred to collectively as “Guest OS”) and other software (illustrated as “Guest Software 112” and “Guest Software 122” and hereafter referred to collectively as “Guest Software”). Each Guest OS and/or Guest Software operates as if it were running on a dedicated computer rather than a virtual machine. That is, each Guest OS and/or Guest Software may expect to control various events and have access to hardware resources on Host 100. In reality, VMM 130 has ultimate control over the events and hardware resources and allocates resources to the Virtual Machines according to its own policies.

Each VM in FIG. 1 typically includes an Advanced Configuration & Power Interface (“ACPI”) driver (“ACPI OS Driver 113” and “ACPI OS Driver 123”) to monitor and/or dynamically reallocate memory. ACPI (e.g., Revision 2.0b, Oct. 11, 2002) is an open industry standard specification for a platform configuration and power management scheme. ACPI drivers exist currently and are well known to those of ordinary skill in the art. These drivers are used to enable typical ACPI interaction between the VMM and the VMs on virtual hosts. Although the following description assumes the use of the ACPI protocol, other configuration protocols may also be utilized without departing from the spirit of embodiments of the present invention.

Various memory resources may be available to Host 100 (illustrated collectively in FIG. 1 as Memory Resources 140, where a portion of Memory Resources 140 may be allocated to VM 110 while another portion may be allocated to VM 120). Allocation of the memory resources to the various VMs on Host 100 is managed by VMM 130. Typically, VMM 130 allocates memory resources to the VMs when the VMs are instantiated. Existing schemes to reallocate these resources to add a new VM are typically cumbersome. For example, VMM 130 may shut down the VMs on Host 100, and then re-launch all the VMs (the original and the new VM), with reallocated resources. This scheme enables the Guest OS in the various VMs to detect the change in memory resources as part of the VM initialization process. The scheme does not, however, enable any type of dynamic reallocation of resources and essentially requires the active VMs on Host 100 be “rebooted” in order to enable instantiation of a new VM.

Alternatively, proprietary software (e.g., a software driver, illustrated conceptually as “Software Driver 150” in VM 110 in FIG. 1) may be added to each of the VMs on Host 100 to handle the reallocation of Memory Resources 140. Software Driver 150 may be responsible for reallocating Memory Resources 140 by effectively removing memory resources from one VM and enabling VMM 130 to reallocate these resources to another VM. Multiple software drivers may have to be created and maintained for different types and/or versions of operating systems. Adding software drivers to the VMs typically involves adding a significant amount of new code to VMM 130. Additionally, these drivers are also likely to require a proprietary interface between the software driver and VMM 130. Ultimately, this scheme is difficult to maintain and may result in stability problems for VMM 130, thus affecting the performance of Host 100.

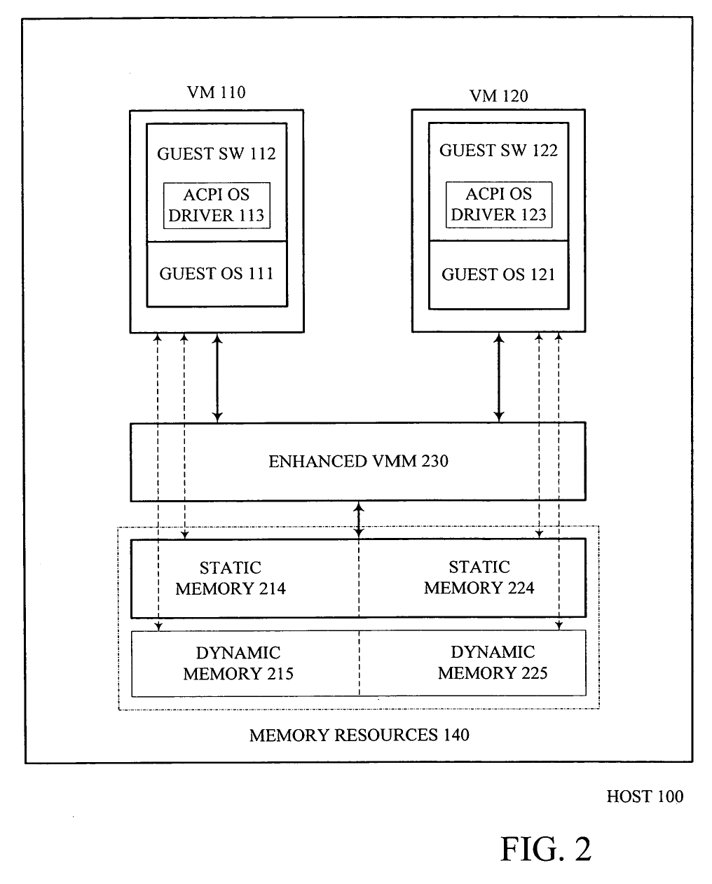

Embodiments of the present invention enable dynamic reallocation of memory resources on a virtualized host. More specifically, in an embodiment of the present invention, memory resources may be reallocated without having to “reboot” the VMs on Host 100 and without the additional software. FIG. 2 illustrates an embodiment of the present invention in further detail. As illustrated, Enhanced VMM 230 may interact with ACPI OS Driver 113 and ACPI OS Driver 123 on the various VMs to monitor and/or dynamically reallocate memory while avoiding the need to add software to the VMs. Enhanced VMM 230 in embodiments of the present invention may utilize the ACPI drivers to dynamically reallocate memory on Host 100 as described in further detail below. It will be readily apparent to those of ordinary skill in the art that Enhanced VMM 230 may comprise enhancements made to an existing VMM and/or to other elements that may work in conjunction with an existing VMM. Enhanced VMM 230 may therefore be implemented in software (e.g., as a standalone program and/or a component of a host operating system), hardware, firmware and/or any combination thereof.

Memory Resources 140 may comprise a “static” portion and a “dynamic” portion. In one embodiment, as illustrated in FIG. 2, a portion of Memory Resources 140 (“Static Memory 214” and “Static Memory 224”) may be dedicated to each VM while another portion of Memory Resources 140 may be dynamically allocated and/or shared between VM 110 and VM 120. In alternate embodiments, all of Memory Resources 140 may be shared by VM 110 and VM 120, i.e., the VMs may not have a static portion of memory dedicated to each but may instead each dynamically be allocated an appropriate amount of memory. For the purposes of explanation, the former assumption (i.e., a static portion and a dynamic portion of memory) is used below. In this embodiment, a portion of the dynamic memory may be initially allocated to each VM (illustrated in FIG. 2 as Dynamic Memory 215 allocated to VM 110 and Dynamic Memory 225 allocated to VM 120), but these portions may be dynamically removed and/or added at any time. According to an embodiment of the present invention, Enhanced VMM 230 may determine that memory resources should be reallocated. This decision may be made automatically, based on criteria provided to Enhanced VMM 230 and/or may be made in response to a request for additional resources from a VM. For the purposes of this example, the assumption is that resources are being removed from VM 110 and reallocated to VM 120.

Upon making the decision to reallocate resources, Enhanced VMM 230 may generate an ACPI General Purpose Event (“GPE”) to VM 110. In one embodiment, the ACPI event generated by Enhanced VMM 230 may be emulated in software, rather than being generated and/or handled by Host 100's hardware. Upon receipt of the GPE, Guest OS 111 in VM 110 may read the ACPI event status register and/or perform other operations (e.g., make inquiries pertaining to configuration registers in the host bus (hereafter “configuration inquiries”)) to determine the purpose of the GPE. Enhanced VMM 130 may intercept these operations and inform VM 110 that Dynamic Memory 215 is being removed. As a result, although the memory is not in fact being “removed”, it will appear so to VM 110. Upon receipt of this information, Guest OS 111 may swap any current information in memory to Host 100's hard disk and thereafter “eject” Dynamic Memory 215, i.e., Guest OS 111 may send a message to Dynamic Memory 215 to inform the memory that it is being shut down and/or removed.

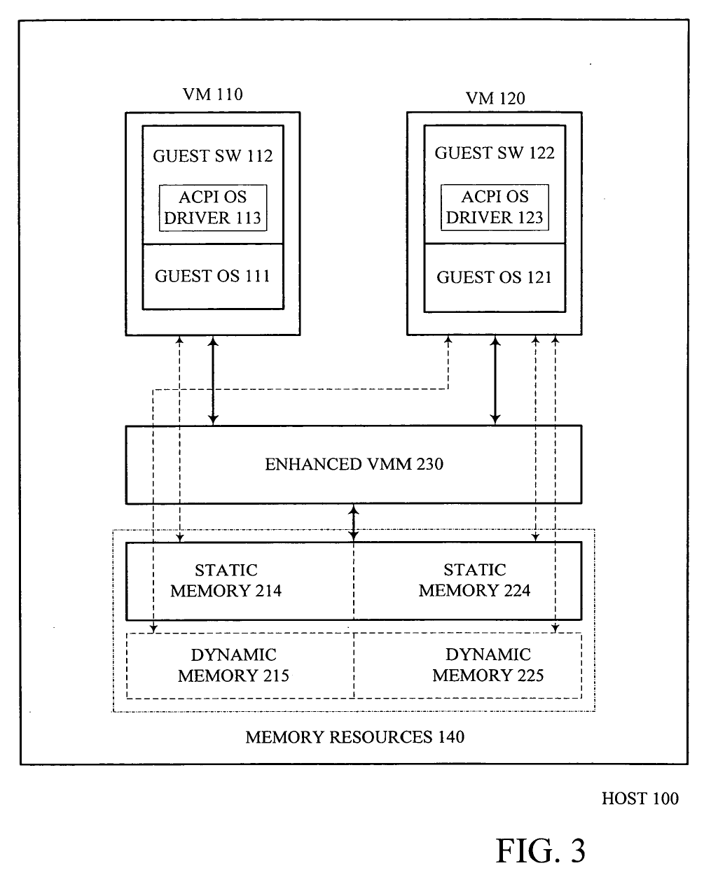

Since in reality Dynamic Memory 215 is not in fact being shutdown, Enhanced VMM 230 intercepts the message from VM 110 to Dynamic Memory 215. Thereafter, Dynamic Memory 215 may be available to be reallocated to another VM. Enhanced VMM 230 may now reassign Dynamic Memory 215 to another VM on Host 100, e.g., VM 120 (as illustrated in FIG. 3). Specifically, in one embodiment, Enhanced VMM 230 may again generate an emulated ACPI GPE, this time to VM 120. Guest OS 121 in VM 120 may read the ACPI event status register and/or perform other operations to determine the reason for the GPE. Again, Enhanced VMM 230 may intercept these operations and inform VM 120 that Dynamic Memory 215 is available. In one embodiment, Enhanced VMM 230 may inform VM 120 by creating device tables (as defined by the ACPI specification) in the memory space in Guest VM 120. Upon receipt of this information, Guest OS 121 in conjunction with ACPI OS Driver 123 may add Dynamic Memory 215 to the memory resources available to VM 120 (e.g., add memory into page tables, etc.) and thereafter have exclusive access to this memory until such time as the device is requested by another VM and/or Enhanced VMM 230 decides to reassign Dynamic Memory 215. Details of how Guest OS 121 and ACPI OS Driver 123 add the memory to VM 121 are well known to those of ordinary skill in the art and further description thereof is omitted herein.

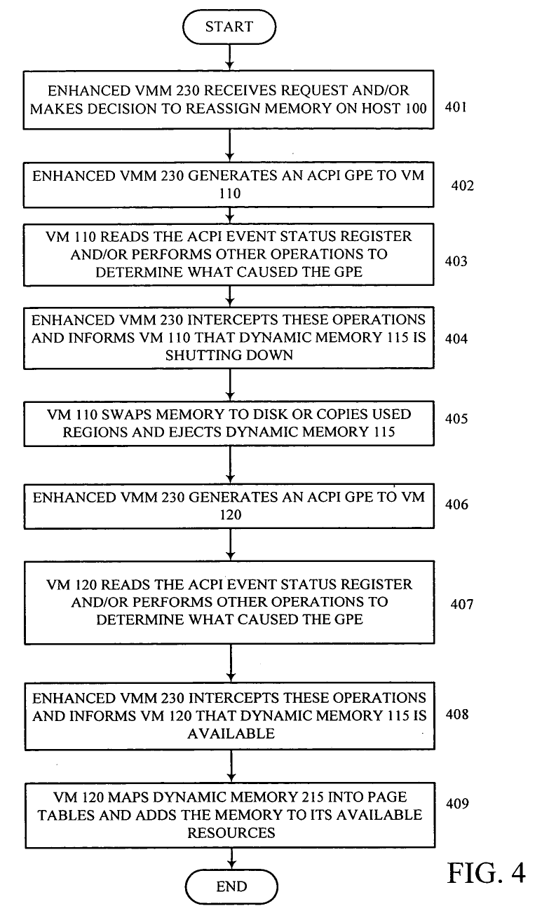

Embodiments of the present invention thus enable Enhanced VMM 230 to dynamically reassign memory from one VM to another without having to reboot Guest OS 111 and Guest OS 121 and without the need for additional software. This flexibility becomes increasingly valuable as more and more VMs are instantiated on Host 100 because the ability to dynamically reallocate memory resources as necessary enables Enhanced VMM 230 to optimize the performance of each VM (e.g., by ensuring that the memory resources are allocated efficiently). FIG. 4 is a flow chart illustrating an overview of an embodiment of the present invention. Although the following operations may be described as a sequential process, many of the operations may in fact be performed in parallel and/or concurrently. In addition, the order of the operations may be re-arranged without departing from the spirit of embodiments of the invention. In 401, Enhanced VMM 230 receives a request and/or makes the decision to reassign Dynamic Memory 215. Enhanced VMM 230 may in 402 generate an ACPI GPE to VM 110 that currently has Dynamic Memory 215 dedicated to it. As previously discussed, although embodiments of the invention are described herein with respect to ACPI, other interfaces and/or protocols may be used to achieve the same effect without departing from the spirit of embodiments of the invention. In 403, Guest OS 111 in VM 110 may read the ACPI event status register and/or perform other operations to determine the cause of the GPE. These operations may be intercepted by Enhanced VMM 230 in 404, and Enhanced VMM 230 may inform VM 110 that Dynamic Memory 215 is shutting down. Guest OS 111 may thereafter in 405 swap information in Dynamic Memory 215 to Host 100's hard disk and eject the device. In 406, Enhanced VMM 230 may send a second ACPI GPE to VM 120. In 407, Guest OS 121 in VM 120 may read the ACPI event status register and/or perform other operations to determine the cause of the GPE. In 408, these operations may be intercepted by Enhanced VMM 230, and Enhanced VMM 230 may inform VM 120 that Dynamic Memory 215 is available. Thereafter, in 409, Guest OS 121 (in conjunction with ACPI OS Driver 123) may map Dynamic Memory 215 to its available resources and may then have exclusive access to Dynamic Memory 215.

Although the above description focuses on hosts running multiple VMs, embodiments of the present invention are not so limited. Instead, embodiments of the invention may be implemented on any platforms with multiple independent computer systems (virtual or otherwise) that share a bus. Thus, for example, in a server system having independent computer systems, one of the computer systems may be used as a backup system for failures. Upon the failure of the main computer system, embodiments of the present invention may be utilized by a monitoring and/or management component to dynamically reassign all memory resources to the backup computer system, thus enabling the server system to continue running without having to reboot any operating systems. Various other types of systems may also benefit from other embodiments of the present invention.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method for dynamically reassigning a memory from a first virtual machine (“VM”) to a second VM, comprising:
notifying the first VM that the memory has been removed;
causing the first VM to issue a shutdown instruction to the memory;
intercepting the shutdown instruction; and
notifying the second VM that the memory is available.

2. The method according to claim 1 wherein notifying the first VM that the memory has been removed further comprises:
generating a first message to the first VM on behalf of the memory;
intercepting a first inquiry from the first VM regarding the cause of the first message; and
informing the first VM in response to the first inquiry that the memory assigned to the first VM is shutting down

3. The method according to claim 2 further comprising causing the first VM to issue an instruction to eject the memory.

4. The method according to claim 1 wherein notifying the first VM that the memory has been removed further comprises notifying the first VM that the memory has been removed according to the Advanced Configuration and Power Interface (“ACPI”) protocol.

5. The method according to claim 1 wherein notifying the second VM that the memory is available further comprises:
assigning the memory to the second VM
generating a second message to the second VM;
intercepting a second inquiry from the second VM regarding the cause of the second message; and
informing the second VM in response to the second inquiry that the memory is available.

6. The method according to claim 5 wherein notifying the second VM that the memory is available further comprises notifying the second VM according to an Advanced Configuration and Power Interface (“ACPI”) protocol.

7. The method according to claim 5 further comprising intercepting configuration inquiries issued by the second VM.

8. The method according to claim 1 further comprising receiving a user request to reassign the memory from the first virtual machine to the second virtual machine.

9. The method according to claim 1 wherein reassigning the memory from the first virtual machine to the second virtual machine is based on a predetermined assignment policy.

10. A host computer system capable of dynamically reassigning a memory, comprising;
a monitoring module;
a first computer system coupled to the monitoring module;
a second computer system coupled to the monitoring module; and
a physical device coupled to the monitoring module, the monitoring module capable of dynamically reassigning the memory from the first computer system to the second computer system by informing the first computer system that the memory has been removed.

11. The system according to claim 10 wherein the monitoring module is further capable of informing the first computer system that the memory has been removed by generating a message to the first computer system.

12. The system according to claim 11 wherein the monitoring module is further capable of intercepting messages issued by the first computer system to the memory.

13. The system according to claim 10 wherein the monitoring module is further capable of assigning the memory to the second computer system and informing the second computer system that the memory is available.

14. The system according to claim 10 wherein the first computer system and the second computer system are virtual machines (“VM”) on a host computer.

15. An article comprising a machine-accessible medium having stored thereon instructions that, when executed by a machine, cause the machine to dynamically reassign a memory from a first virtual machine (“VM”) to a second VM by:
notifying the first VM that the memory has been removed;
causing the first VM to issue a shutdown instruction to the memory;
intercepting the shutdown instruction; and
notifying the second VM that the memory is available.

16. The article according to claim 15 wherein the instructions, when executed by the machine, further cause the machine to notify the first VM that the memory has been removed by:
generating a first message to the first VM on behalf of the memory;
intercepting a first inquiry from the first VM regarding the cause of the first message; and
informing the first VM in response to the first inquiry that the memory assigned to the first VM is shutting down.

17. The article according to claim 16 wherein the instruction, when executed by the machine, further cause the machine to cause the first VM to issue an instruction to eject the memory.

18. The article according to claim 15 wherein the instructions, when executed by the machine, further cause the machine to notify the first VM that the memory has been removed according to the Advanced Configuration and Power Interface (“ACPI”) protocol.

19. The articled according to claim 15 wherein the instructions, when executed by the machine, further cause the machine to notify the second VM that the memory is available by:
assigning the device to the second VM
generating a second message to the second VM;
intercepting a second inquiry from the second VM regarding the cause of the second message; and
informing the second VM in response to the second inquiry that the memory is available.

20. The article according to claim 19 wherein the instructions, when executed by the machine, further cause the machine to notify the second VM that the memory is available according to an Advanced Configuration and Power Interface (“ACPI”) protocol.
